(19) United States
(12) Patent Application Publication
(10) Pub. No.: US 2023/0266993 A1
(43) Pub. Date: Aug. 24, 2023

(54) Methods and Systems for Compensating for System Delays and Inefficiencies

(71) Applicant: Eaton Intelligent Power Limited, Dublin 4 (IE)

(72) Inventors: Swanand Juvekar, Cary, NC (US); Steven Andrew Moore, Raleigh, NC (US); Webb Lewis Burgess, Raleigh, NC (US)

(21) Appl. No.: 18/170,828

(22) Filed: Feb. 17, 2023

Related U.S. Application Data
(60) Provisional application No. 63/311,528, filed on Feb. 18, 2022.

(51) Int. Cl. G06F 9/48; G06F 11/34

(52) U.S. Cl. CPC G06F 9/4831; G06F 11/3409

(57) ABSTRACT

Methods for adjusting a resource response in a resource system are provided including capturing and storing current performance data associated with the resource system; performing a regression analysis on the captured and stores current performance data to provide a best linear regression fit; developing a compensation equation based on the best linear regression fit; programming the compensation equation into a compensation module at resource controller at the resource system; and adjusting, at the resource controller, incoming signals from a control center to compensate for system non-idealities to provide an adjusted system. Related systems are also provided.

### CLAIM OF PRIORITY

The present application claims the benefit of and priority to U.S. Provisional Application No. 63/311,528, filed on Feb. 18, 2022 entitled METHODS AND SYSTEMS FOR COMPENSATING FOR SYSTEM DELAYS AND INEFFICIENCIES, the content of which is hereby incorporated herein by reference as if set forth in its entirety.

### FIELD

The present inventive concept relates to ancillary service and, more particularly, to methods for improving ancillary service performance.

### BACKGROUND

An interconnected network for electricity delivery from “producers” to “consumers” is called an electric grid. Electric grids vary in size and can cover entire countries or continents. The grid may include power stations often located near energy and away from heavily populated areas, electrical substations to step voltage up or down, electric power transmission to carry power long distance, and electrical power distribution to individual customers where voltage is stepped down again to the required service voltage(s).

In the United States, Regional Transmission Organizations (RTOs) such as Pennsylvania, New Jersey, and Maryland (PJM) and Independent System Operators (ISOs) such as California ISO (CAISO) coordinate, control, and monitor a multi-state electric grid. Using the data obtained from the monitoring system, these organizations run an Automatic Generation Control (AGC) algorithm that helps decide on actions to increase stability of electric grid.

In particular, AGC is a system for adjusting the power output of multiple generators at different power plants in response to changes in the load, i.e., a component or portion of a grid that consumes power (“consumer”). Since the electric grid requires that production by the generators and consumption by the load closely balance moment by moment, frequent adjustments to the output of generators are necessary. The balance can be judged by measuring the system frequency. Generally, if the frequency is increasing, the grid is generating more power than is being used, which causes all the machines in the system to accelerate. On the other hand, if the system frequency is decreasing, more load is on the system than the instantaneous generation can provide, which causes all generators to slow down.

Frequency regulation is one of the “ancillary services” that RTOs and ISOs allow private resources to participate in, adjusting their generation or load in response to the needs of the grid. Private resources are paid for the service based on their performance. Use of these private resources help RTOs and ISOs keep the electric grid stable without having to use more expensive resources.

### SUMMARY

Some embodiments of the present inventive concept provide methods for adjusting a resource response in a resource system, the method including capturing and storing current performance data associated with the resource system; performing a regression analysis on the captured and stored current performance data to provide a best linear regression fit; developing a compensation equation based on the best linear regression fit; programming the compensation equation into a compensation module at resource controller at the resource system; and adjusting, at the resource controller, incoming signals from a control center to compensate for system non-idealities to provide an adjusted system.

In further embodiments, a test signal may be initialized to test the performance of the system and performance data may be generated therefrom. In certain embodiments a signal having a predetermined length may be transmitted to a resource in the resource system to mimic an incoming command from a control center and performance of the resource may be tracked based on performance of the signal. The predetermined length of the signal may be two seconds.

In still further embodiments, the regression analysis may be a statistical method that allows examination of a relationship between two or more variables presented by the captured performance data.

In some embodiments, actual performance of the resource system may not be ideal and which is represented by a distribution of points around a line y=x. The adjusted system may have a performance that is substantially similar to ideal performance than the resource system before adjustment.

In further embodiments, the compensated system may provide a resource response that is in line with an incoming command from a control center and provide improved resource precision and performance scores.

In still further embodiments, a precision metric of the performance scores may be improved from mid-70s to low-90s and the performance scores may be based on at least accuracy, delay and precision.

In some embodiments, the compensation equation may be determined based on an incoming signal (RegD) and system performance (Creg). In certain embodiments, the compensation equation may be determined using linear regression on a performance data set.

Related system embodiments are also provided herein.

### BRIEF DESCRIPTION OF THE DRAWINGS

FIG. 1 is a block diagram of an ancillary system in accordance with some embodiments of the present inventive concept.

FIG. 2 is a block diagram of a resource controller including a compensation module in accordance with some embodiments of the present inventive concept.

FIG. 3 is a flowchart illustrating operations of the compensation module in accordance with some embodiments of the present inventive concept.

FIG. 4 is a graph illustrating incoming signal (RegD) versus system performance (Creg) in an ideal system.

FIG. 5 is a graph illustrating RegD versus Creg in a system that does not include compensation.

FIG. 6 is a graph illustrating RegD versus Creg in a compensated system in accordance with some embodiments of the present inventive concept.

FIG. 7 is a block diagram of a data processing system for use in accordance with some embodiments of the present inventive concept.

### DETAILED DESCRIPTION OF EMBODIMENTS

The inventive concept now will be described more fully hereinafter with reference to the accompanying drawings, in which illustrative embodiments of the inventive concept are shown. This inventive concept may be embodied in many different forms and should not be construed as limited to the embodiments set forth herein; rather, these embodiments are provided so that this disclosure will be thorough and complete and will fully convey the scope of the inventive concept to those skilled in the art. Like numbers refer to like elements throughout. As used herein, the term “and/or” includes any and all combinations of one or more of the associated listed items. Similarly, as used herein, the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Reference will now be made in detail in various and alternative example embodiments and to the accompanying figures. Each example embodiment is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations that come within the scope of the appended claims and their equivalents.

As discussed above, Regional Transmission Organizations (RTOs) such as Pennsylvania, New Jersey, and Maryland (PJM) and Independent System Operators (ISOs) such as California ISO (CAISO) coordinate, control, and monitor a multi-state electric grid. Frequency regulation is one of the “ancillary services” that RTOs and ISOs allow private resources to participate in and the private resources are paid for the service based on their performance. RTOs and ISOs may be referred to collectively herein as control centers. Since these private companies/resources are paid based on their performance, it is important that the system associated with the private resource meet the standards set by the RTO/ISO. However, this may be difficult as private resources performing an ancillary service like frequency regulation require a complex system involving multiple components, which inherently introduces inefficiencies into the system at various stages. The inefficiencies can result in a significant impact on the ability to accurately track an incoming command signal from the RTO/ISO. The resulting error directly impacts the precision component of the performance score, which reduces the current and future revenue the private resource generates as payment for the ancillary services and may affect being utilized for ancillary services in the future.

Accordingly, some embodiments of the present inventive concept provide methods for improving utility ancillary service performance so that the performance score meets the standards set by the RTOs/ISOs and, therefore, the private resource can generate maximum income and maintain contracts for the ancillary services. As will be discussed below, some embodiments of the present inventive concept provide methods of mitigating the inefficiencies discussed above using a single compensation equation, which can be programmed into an internal controller of the system of the private resource, for example, an uninterruptible power supply (UPS). In a particular example, this method was used on an EnergyAware UPS offered by Eaton and the performance score of the resource/UPS was significantly improved. Specifically, the precision metric of the performance score improved from mid-70s to low-90s, thus, increasing the composite performance score to mid-90s for the EnergyAware UPS system. Methods and systems in accordance with embodiments of the present inventive concept will be discussed below.

It will be understood that although some embodiments of the present inventive concept will be discussed with respect UPSs, embodiments of the present inventive concept are not limited thereto. Any ancillary resource/system that may benefit from the methods and systems discussed herein may be used without departing from the scope of the present inventive concept. Methods and systems discussed herein can be applied to any grid resource and multiple grid ancillary services.

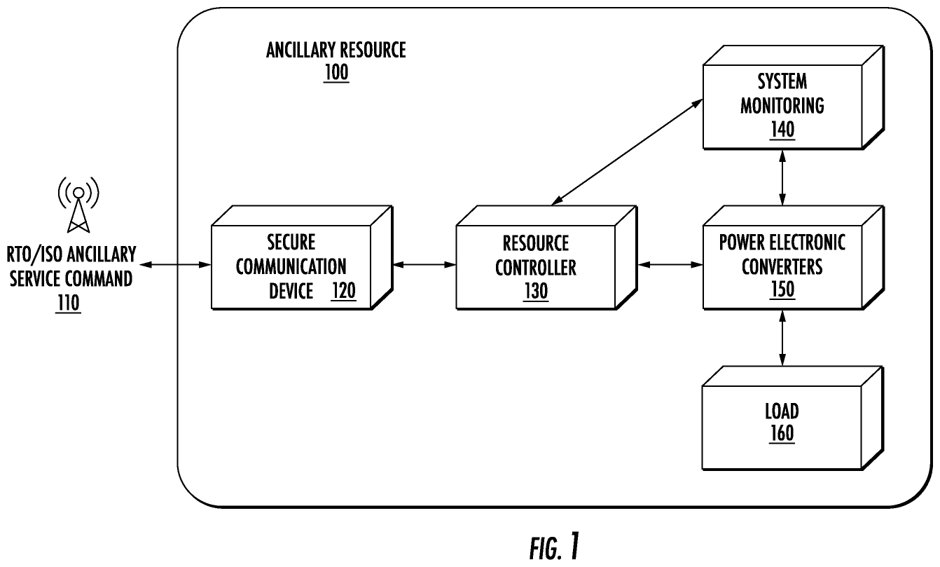

Referring now to FIG. 1, an example ancillary resource for an electric grid will be discussed in accordance with some embodiments of the present inventive concept. As illustrated in FIG. 1, the grid resource system 100 participating in ancillary services includes a secure communication device 120, a resource controller 130, a set of power electronic converters 150, a monitoring system 140 and a load 160 (consumers). As further illustrated, communication equipment 120 establishes a communications channel to the RTO/ISO ancillary service command 110.

The RTO/ISO 110 sends a “command” to the ancillary resource 100 using the communication device 120. The command is sent to the resource 100 and an internal resource controller 130 passes the incoming command to the set of power electronic converters 150. Using the system monitoring 140, the performance of the power electronic converters 150 is monitored and a state of the resource is obtained. For example, the RTO/ISO 110 may expect a response within a predetermined period of time such as 2 seconds. If the resource fails to respond within the predetermined time period, the performance score will suffer.

As discussed above, the overall system is generally complex and involves numerous components. For example, there are several layers: higher-level software, internal (EnergyAware) controller, converter communication network and the like, through which an incoming command signal from the RTO/ISO 110 needs to traverse before the power electronic converters 150 can act on the signal. Due to the number of components being traversed, a delay is generally introduced while executing the incoming command from the RTO/ISO 120 to the resource 100. Furthermore, as the grid resource converter follows the signal, it is executing its own controls based on the feedback signal it gets from its sensor network. As with any physical system, there are tolerances and inefficiencies associated with hardware sensing which affect the accuracy achieved by the power electronic converters in following the command.

Accordingly, some embodiments of the present inventive concept provide methods and systems that mitigate the inefficiencies discussed above using a single compensation equation. Although examples discussed herein relate specifically to a Frequency Regulation application, it will be understood that methods and systems in accordance with embodiments discussed herein can be applied to a variety of grid services without departing from the scope of the present inventive concept.

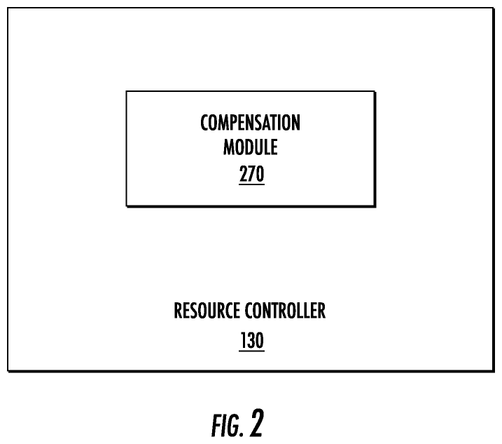

Referring now to FIG. 2, a resource controller 130 in accordance with some embodiments of the present inventive concept will be discussed. As illustrated in FIG. 2, the resource controller 130 includes a compensation module 270 configured in accordance with some embodiments of the present inventive concept. Although the resource controller 130 is only shown including the compensation module 270, it will be understood that the resource controller 130 also includes all known elements of the resource controller, which have been left out of FIG. 2 for brevity.

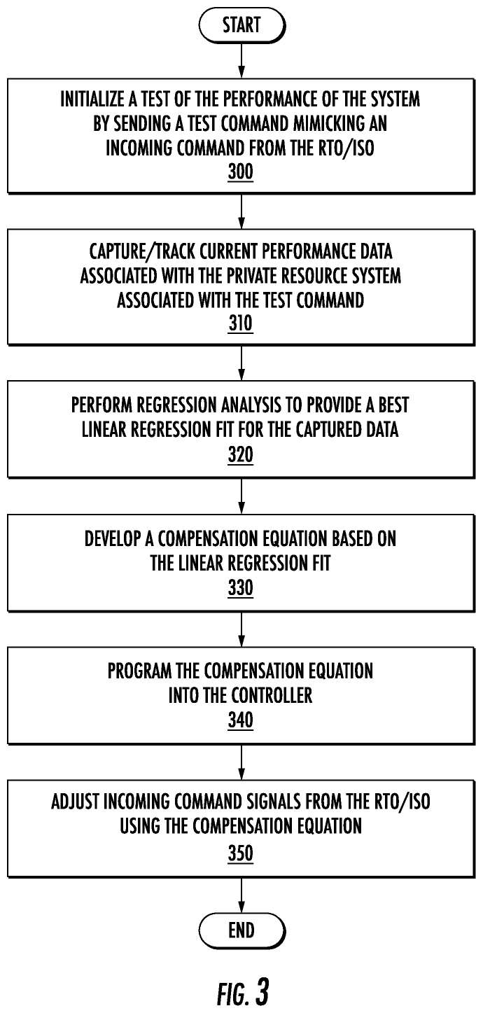

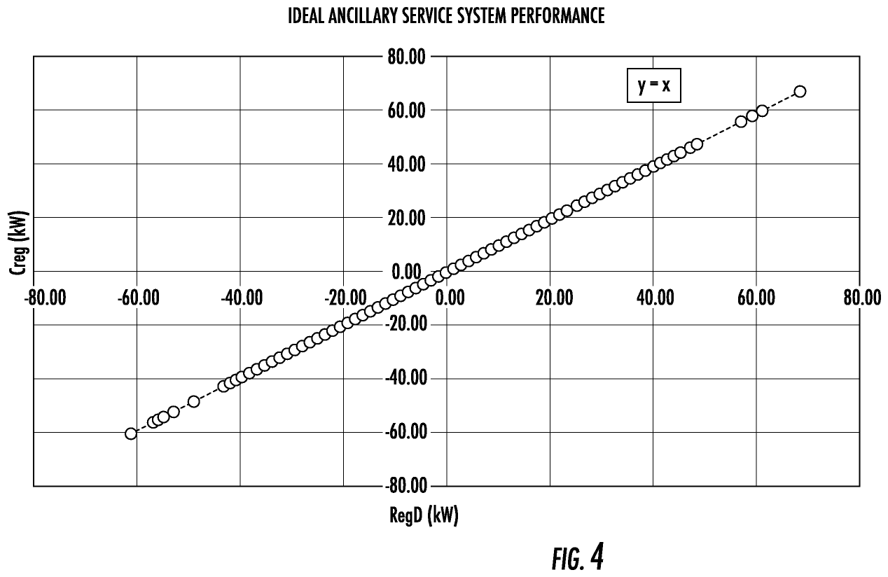

Referring now to FIG. 3, a flowchart illustrating operations of compensation modules 270 in accordance with some embodiments of the present inventive concept will be discussed. As illustrated in FIG. 3, operations for deriving a compensation equation begin at block 300 by capturing and storing current performance data associated with the resource system. For example, current performance data may be captured by initializing a test signal to test the performance of the system. Generally, the RTO/ISO 110 requires the resource to respond to a command within a pre-defined period of time, for example, within 2 seconds. Accordingly, for testing purposes, a pre-determined 2-second signal is sent to the resource to emulate (mimic) an incoming command from RTO/ISO (block 300) and the resource's performance is tracked (block 310). It will be understood that an ideal resource performance should match the incoming command signal. In other words, when response (y) is plotted against incoming signal (x), it should follow line y=x as shown in, for example, FIG. 4.

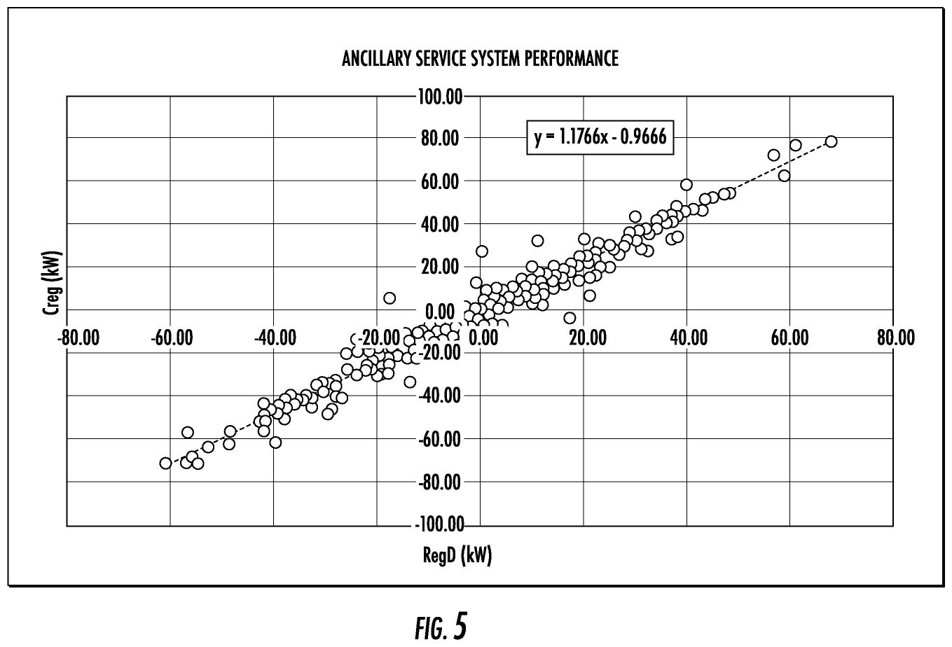

As discussed above, due to delays and inefficiencies, actual performance of the system is usually not ideal and is seen as a distribution of points around the y=x line. An example graph of actual performance of an Ancillary Service System is illustrated in the graph of FIG. 5. Thus, some embodiments of the present inventive concept provide methods and systems that compensate for the deviation from the ideal performance of FIG. 4 and the actual performance of FIG. 5.

Referring again to FIG. 3, once the performance data is captured based on the test command, a regression analysis is performed to develop the best linear regression fit to captured data (block 320). Any type of regression analysis may be used without departing from the scope of the present inventive concept. Generally, regression analysis is a statistical method that allows examination of the relationship between two or more variables of interest. While there are many types of regression analysis, at their core all types of regression analysis examine the influence of one or more independent variables on a dependent variable.

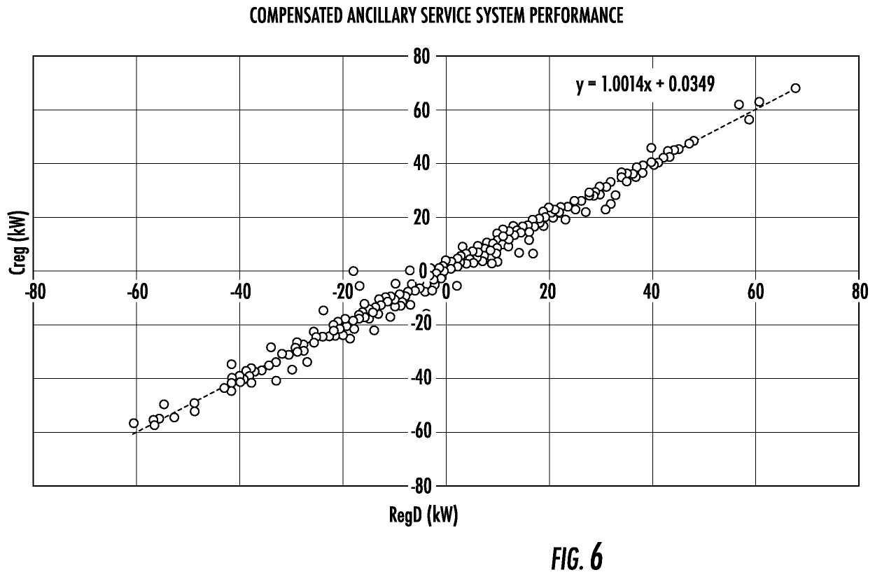

Once the regression analysis is completed, a compensation equation is developed using the outcome of the regression analysis (block 330). Once the compensation equation is developed, the compensation equation is programmed into the compensation module 270 of the resource controller 130 (block 340) such that the resource controller 130 adjusts the incoming signals from the RTO/ISO to compensate for all the system non-idealities (block 350). With this adjustment of the incoming signal using the compensation equation, the performance of the adjusted system illustrated, for example, in FIG. 6, comes much closer to the ideal situation illustrated in FIG. 4. In other words, the compensated result provides a resource response that is in line with the incoming command from the RTO/ISO, which significantly improves the resource precision and the performance score.

An example of the methods/systems will now be discussed. It will be understood that this is an example and embodiments of the present inventive concept are not limited thereto. The example is discussed in the context of an EnergyAware UPS provided by Eaton, however, other devices/systems may be used without departing from the scope of the present inventive concept.

Performance scores for Pennsylvania, New Jersey, Maryland (PJM) frequency regulation service are broken down into three categories:

Accuracy: The correlation or degree of relationship between control.

Delay: The time delay between control signal and point of highest correlation.

Precision: The instantaneous error between the control signal and the regulating unit's response.

Without any compensation in the system, i.e. without using the compensation equation discussed herein, the score breakdown for one hour of live signal operation was as follows:

Accuracy: 0.9722;

Delay: 0.9998;

Precision: 0.7205; and

Composite: 0.8975.

By plotting the incoming signal (RegD) versus system performance (Creg), the behavioral equation was determined to be:

Creg=1.1766*RegD−0.9666 Eqn. (1)

This behavioral equation was determined through a linear regression performed on the data set. This data and equation are illustrated in FIG. 5 showing the Ancillary Service System Performance.

A compensation equation for the EnergyAware UPS system was generated using the coefficients of Eqn. (1). After applying this compensation algorithm, the same signal discussed above was run through the compensated system. The score breakdown of the compensated system was as follows:

Accuracy: 0.9881;

Delay: 1.0000;

Precision: 0.8872; and

Composite: 0.9584.

Furthermore, when plotting the incoming signal (RegD) versus system performance (Creg), the behavioral equation was as follows:

Creg=1.0014*RegD+0.0349 Eqn. (2)

This result is substantially closer to the ideal Creg=RegD illustrated in FIG. 4. Results of the compensated system are illustrated in FIG. 6 illustrating the Compensated Ancillary Service System Performance.

The example discussed above illustrates the improved performance score provided by the compensation methodology discussed herein with respect to the EnergyAware UPS. It will be understood that methods and systems discussed herein can be used in any application to drastically improve the precision score and, thus, lead to increased revenue generated from ancillary services.

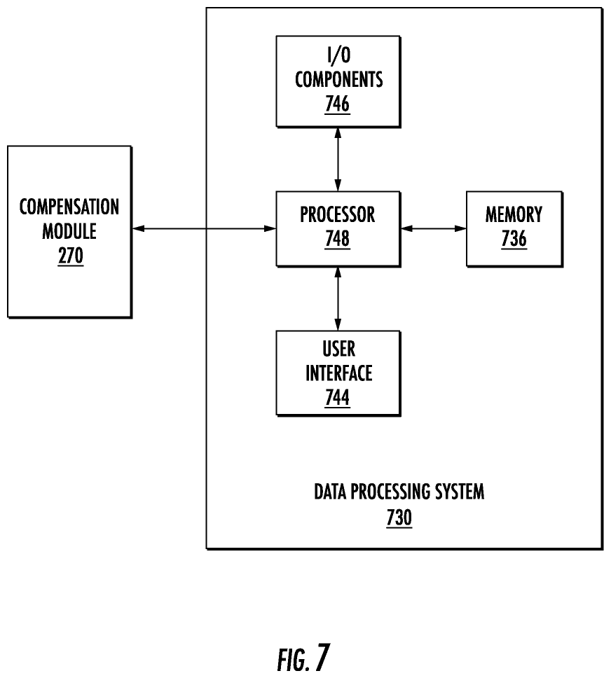

As is clear from the details of the present inventive concept, embodiments of the present inventive concept require data processing. Referring now to FIG. 7, an example of a data processing system 730 suitable for use with any of the examples described above will be discussed. Although the example data processing system 730 is shown as in communication with the compensation module 270 in accordance with embodiments of the present inventive concept, the data processing system 730 may be part of any component of the system without departing from the scope of the present inventive concept. In some examples, the data processing system 730 can be any suitable computing device for performing operations according to the embodiments discussed herein described herein.

As illustrated, the data processing system 730 includes a processor 748 communicatively coupled to I/O components 746, a user interface 744 and a memory 736. The processor 748 can include one or more commercially available processors, embedded processors, secure processors, microprocessors, dual microprocessors, multi-core processors, other multi-processor architectures, another suitable processing device, or any combination of these. The memory 736, which can be any suitable tangible (and non-transitory) computer-readable medium such as random-access memory (RAM), read-only memory (ROM), erasable and electronically programmable read-only memory (EEPROMs), or the like, embodies program components that configure operation of the data processing system 730.

I/O components 746 may be used to facilitate wired or wireless connections to devices such as one or more displays, game controllers, keyboards, mice, joysticks, cameras, buttons, speakers, microphones and/or other hardware used to input or output data. Memory 736 represents nonvolatile storages such as magnetic, optical, or other storage media included in the data processing system and/or coupled to processor 748.

The user interface 744 may include, for example, a keyboard, keypad, touchpad, voice activation circuit, display or the like and the processor 748 may execute program code or instructions stored in memory 736.

It should be appreciated that data processing system 730 may also include additional processors, additional storage, and a computer-readable medium (not shown). The processor(s) 748 may execute additional computer-executable program instructions stored in memory 736. Such processors may include a microprocessor, digital signal processor, application-specific integrated circuit, field programmable gate arrays, programmable interrupt controllers, programmable logic devices, programmable read-only memories, electronically programmable read-only memories, or other similar devices.

As discussed briefly above, some embodiments of the present inventive concept provide methods and systems that may significantly increase grid resource performance by improving the ability to track incoming commands from the RTO/ISO. Better tracking of incoming commands both generates immediate higher revenue for the private resource and positions the private resources to get more opportunities to perform the ancillary service in future, which will by definition generate further revenue.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Further, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Further, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C #, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Nonvolatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A method for adjusting a resource response in a resource system, the method comprising:
capturing and storing current performance data associated with the resource system;
performing a regression analysis on the captured and stored current performance data to provide a best linear regression fit;
developing a compensation equation based on the best linear regression fit;
programming the compensation equation into a compensation module at resource controller at the resource system; and
adjusting, at the resource controller, incoming signals from a control center to compensate for system non-idealities to provide an adjusted system.

2. The method of claim 1, wherein capturing current performance data comprises: initializing a test signal to test the performance of the system and generating the performance data therefrom.

3. The method of claim 2, wherein initializing a test signal further comprises transmitting a signal having a predetermined length to a resource in the resource system to mimic an incoming command from a control center and wherein generating the performance data comprises tracking performance of the resource based on performance of the signal.

4. The method of claim 3, wherein the predetermined length of the signal is two seconds.

5. The method of claim 1, wherein the regression analysis is a statistical method that allows examination of a relationship between two or more variables presented by the captured performance data.

6. The method of claim 1, wherein actual performance of the resource system is not ideal and is represented by a distribution of points around a line y=x and wherein the adjusted system has a performance that is substantially similar to ideal performance than the resource system before adjustment.

7. The method of claim 1, wherein the compensated system provides a resource response that is in line with an incoming command from a control center and provides improved resource precision and performance scores.

8. The method of claim 7, wherein a precision metric of the performance scores improved from mid-70s to low-90s and wherein performance scores are based on at least accuracy, delay and precision.

9. The method of claim 1, wherein determining the compensation equation comprises determining the compensation equation based on an incoming signal (RegD) and system performance (Creg).

10. The method of claim 9, wherein determining the compensation equation further comprises determining the compensation equation using linear regression on a performance data set.

11. A resource system including a resource controller for adjusting the system, the resource system including a secure communication device, a resource controller, power electronic converters, a monitoring system and a load, wherein the resource controller:
captures and stores current performance data associated with the resource system;
performs a regression analysis on the captured and stored current performance data to provide a best linear regression fit;
develops a compensation equation based on the best linear regression fit;
programs the compensation equation into a compensation module at resource controller at the resource system; and
adjusts incoming signals from a control center to compensate for system non-idealities to provide an adjusted system.

12. The resource system of claim 11, wherein the system captures current performance data by initializing a test signal to test the performance of the system and generating the performance data therefrom.

13. The resource system of claim 12, wherein the system initializes a test signal by transmitting a signal having a predetermined length to a resource in the resource system to mimic an incoming command from a control center and generates the performance data by tracking performance of the resource based on performance of the signal.

14. The resource system of claim 13, wherein the predetermined length of the signal is two seconds.

15. The resource system of claim 11, wherein the regression analysis is a statistical method that allows examination of a relationship between two or more variables presented by the captured performance data.

16. The resource system of claim 11, wherein actual performance of the resource system is not ideal and is represented by a distribution of points around a line y=x and wherein the adjusted system has a performance that is substantially similar to ideal performance than the resource system before adjustment.

17. The resource system of claim 11, wherein the compensated system provides a resource response that is in line with an incoming command from a control center and provides improved resource precision and performance scores.

18. The resource system of claim 17, wherein a precision metric of the performance scores improved from mid-70s to low-90s and wherein performance scores are based on at least accuracy, delay and precision.

19. The resource system of claim 11, wherein the system determines the compensation equation by determining the compensation equation based on an incoming signal (RegD) and system performance (Creg).

20. The resource system of claim 19, wherein the system determines the compensation equation by determining the compensation equation using linear regression on a performance data set.
